(19) United States
(12) Patent Application Publication
(10) Pub. No.: US 2008/0276389 A1
(43) Pub. Date: Nov. 13, 2008

(54) CITRUS FRUITS POLISHING APPARATUS

(76) Inventor: Mitsuo NISHIMURA, Kochi-shi (JP)

Correspondence Address: BERENATO, WHITE & STAVISH, LLC, 6550 ROCK SPRING DRIVE, SUITE 240, BETHESDA, MD, 20817, US

(21) Appl. No.: 12/114,880

(22) Filed: May 5, 2008

(30) Foreign Application Priority Data
May 8, 2007 (JP) 2007-3265

(51) Int. Cl. A23N 12/00

(52) U.S. Cl. 15/3.1; 15/3.19

(57) ABSTRACT

A citrus fruits polishing apparatus polishes citrus fruits in a short period of time with a simple arrangement before shipping the citrus fruits to increase the visual quality and enhance the commercial value thereof.

The citrus fruits polishing apparatus includes a support board fixed to an open bottom of a cylindrical member, a motor fixed to the support board with a revolving shaft protruding upward, a bearing mounted over a revolving shaft of the motor, a turn disk rotatably fixed to the bearing, a disk polisher fixed to the turn disk and a cylindrical polisher fixed to the inner periphery of the cylindrical member. A plurality of legs are fixed to the external face of the cylindrical member at predetermined intervals to support the apparatus at a predetermined height. The turn disk is rotated intermittently, and the rotation direction of the turn disk is reversed at every predetermined time.

### CROSS-REFERENCE TO RELATED APPLICATIONS AND CLAIM TO PRIORITY

This application is based upon utility model application no. 2007/3265 filed May 8, 2007, the disclosure of which is incorporated herein by reference and to which priority is claimed.

### FIELD OF THE INVENTION

The present invention relates to a polishing apparatus for citrus fruits such as pomelos, tangerines, oranges, grapefruits, kumquats, tangors, aromatic citrus fruits and other citrus fruits. Particularly, the present invention relates to a polishing apparatus for polishing citrus fruits before shipping to increase the visual quality and enhance the commercial value thereof.

### BACKGROUND OF THE INVENTION

Citrus fruits emit a pleasant smell and taste sweet and sour, and are one of the most popular fruits. Since bright skins of citrus fruits look fresh and delicious, citrus fruits are washed and polished before shipping them. Further, in order to increase the visual quality, some citrus fruits are artificially polished using polishing wax. Conventionally, each citrus fruit was polished by hand using a polishing cloth.

Japanese Unexamined Patent Publication (Kokai) No. 2002-101863 discloses a washing apparatus for washing spherical fruits like watermelons. To prevent spherical fruits from coming into contact with each other and being damaged on the surface thereof while rubbing with each other during washing, the washing apparatus is arranged as described below. That is, brushes are formed so that the length of the brushes gradually becomes longer from the outer side toward the inner side; a transfer roller is disposed via right and left chains laid around driving sprockets and driven sprockets located at the front end and the rear end in the transfer direction; fixed brushes hang from the ceiling of the washing apparatus along the transfer direction; and each of the fixed brushes are formed in a Y-shape or V-shape in cross-section by arranging the length of the brushes to gradually become longer from the outer side toward the inner side so as to fill the space formed by the spherical fruits while being transferred in parallel to each other on the roller surface.

Also, Japanese Unexamined Patent Publication (Kokai) No. 07-298863 discloses a vegetable washing apparatus, which washes an object to be washed with water such as root vegetables, or other similar vegetables or fruits. The vegetable washing apparatus is arranged as described below. That is, a pair of roll brushes is disposed in a longitudinal direction along a longitudinal direction of a casing and is driven to rotate in the same direction. Above the roll brushes oriented in a longitudinal direction, washing and transfer paths, on which objects to be washed are transferred in a longitudinal direction, are formed. Above the washing and transfer path, a plurality of lateral roll brushes, which are driven to rotate on a rotation axle perpendicular to the roll brushes oriented in the longitudinal direction, is disposed. Each of the lateral roll brushes is supported by a flexible support mechanism so as to be independently movable in a vertical direction with respect to the washing and transfer path. The lateral roller brushes impart a force to transfer the objects to be washed toward the downstream.

Due to being inefficient, and excessively time-consuming and labor-intensive, the conventional manner in which each citrus fruit is polished by hand using a polishing cloth imposes a large burden on workers. Therefore, in a busy season of shipping of citrus fruits, it is difficult to carry out the polishing work sufficiently. Further, waxes used for polishing citrus fruits are undesirable to the human body.

The washing apparatus for spherical fruits and the like disclosed in Japanese Unexamined Patent Publication (Kokai) No. 2002-101863 performs just brushing from one direction, and is not sufficient to polish citrus fruits for increasing their visual quality. Further, since a complicated mechanism is required, the apparatus is not suitable for farmers to operate at a shipping site of citrus fruits. That is, it is difficult to extract the oil content contained in the skin of citrus fruits to the surface thereof and polish the citrus fruits utilizing the oil content by carrying out only the brushing. The vegetable washing apparatus disclosed in Japanese Unexamined Patent Publication (Kokai) No. 07-298863 performs washing with water. Therefore, the vegetable washing apparatus is inapplicable to polishing work of citrus fruits. As described above, conventionally, although several applications relevant to washing apparatus are found, there is no application relevant to a polishing apparatus for citrus fruits.

### SUMMARY OF THE INVENTION

It is an object of the invention to provide a citrus fruits polishing apparatus capable of polishing citrus fruits in a short time with a simple arrangement to increase the visual quality and enhance the commercial value of the citrus fruits before shipping thereof.

In order to achieve the above object, the invention provides a citrus fruits polishing apparatus, which basically includes a disk polisher fixed to a turn disk driven to rotate and a cylindrical polisher fixed to the inner periphery of a cylindrical member vertically disposed around the turn disk. More particularly, the citrus fruits polishing apparatus includes a support board fixed to an open bottom of a cylindrical member, a motor fixed to the support board with a revolving shaft protruding upward, a bearing mounted over the revolving shaft of the motor, a turn disk rotatably fixed to the bearing, a disk polisher fixed onto the turn disk and a cylindrical polisher fixed to the inner periphery of the cylindrical member, and a plurality of legs is fixed to the external face of the cylindrical member at predetermined intervals to thereby support the cylindrical member at a predetermined height. Also, the turn disk is driven to rotate intermittently, and the turn disk is driven to reverse the rotation direction thereof regularly or at random. Further, the turn disk is driven to rotate for a predetermined set period of time.

The turn disk is driven to rotate to cause citrus fruits placed on the disk polisher to roll to thereby bring the citrus fruits into contact with the disk polisher and the cylindrical polisher, whereby the citrus fruits are polished. The turn disk is driven to rotate to cause citrus fruits placed on the disk polisher to roll to thereby bring the citrus fruits into contact with the disk polisher, the cylindrical polisher and with each other, whereby the oil content is extracted to the skin of the citrus fruits and the citrus fruits are polished therewith. Further, the turn disk is driven to rotate to cause citrus fruits placed on the disk polisher to roll to thereby bring the citrus fruits into contact with the disk polisher, the cylindrical polisher and with each other, whereby the oil content is extracted to the skin of the citrus fruits and the skin of the citrus fruits is polished by the disk polisher and the cylindrical polisher to give luster to the skin thereof.

According to the citrus fruits polishing apparatus of the invention, the citrus fruits are caused to roll on the disk polisher due to the rotation of the turn disk, and by repeated contact with the disk polisher and the cylindrical polisher vertically disposed around the disk polisher the citrus fruits are polished to be given luster. Also, when the citrus fruits roll and come into contact with the disk polisher and the cylindrical polisher, the oil content is extracted to the skin of the citrus fruits, and the polishing is carried out utilizing the oil content. Further, when the citrus fruits appropriately come into contact with each other, it promotes the extraction of the oil content, and the rolling of the citrus fruits facilitates the polishing. Accordingly, the polishing is carried out in a short time with a simple arrangement and thus, the visual quality of the citrus fruits is increased and the commercial value thereof is enhanced.

### BRIEF DESCRIPTION OF THE DRAWINGS

FIG. 1 is a perspective view of a citrus fruits polishing apparatus according to the invention.

FIG. 2 is a side elevational view of the citrus fruits polishing apparatus in FIG. 1.

FIG. 3 is an exploded assembly drawing of the citrus fruits polishing apparatus.

FIG. 4 is a fragmentary vertical sectional view of an essential part of the citrus fruits polishing apparatus along a centerline thereof.

FIG. 5 is a perspective view of the citrus fruits polishing apparatus in use.

### DETAILED DESCRIPTION OF THE INVENTION

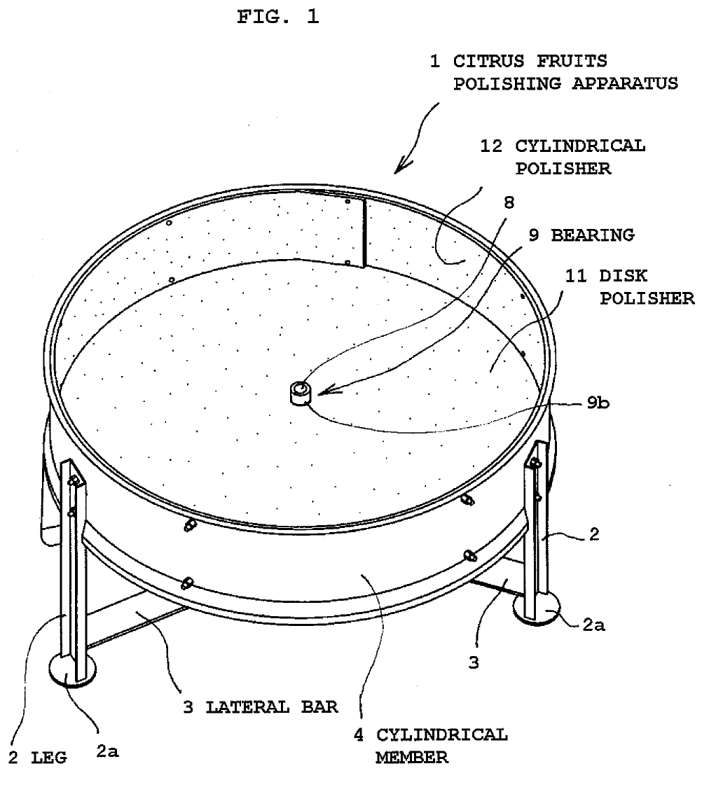

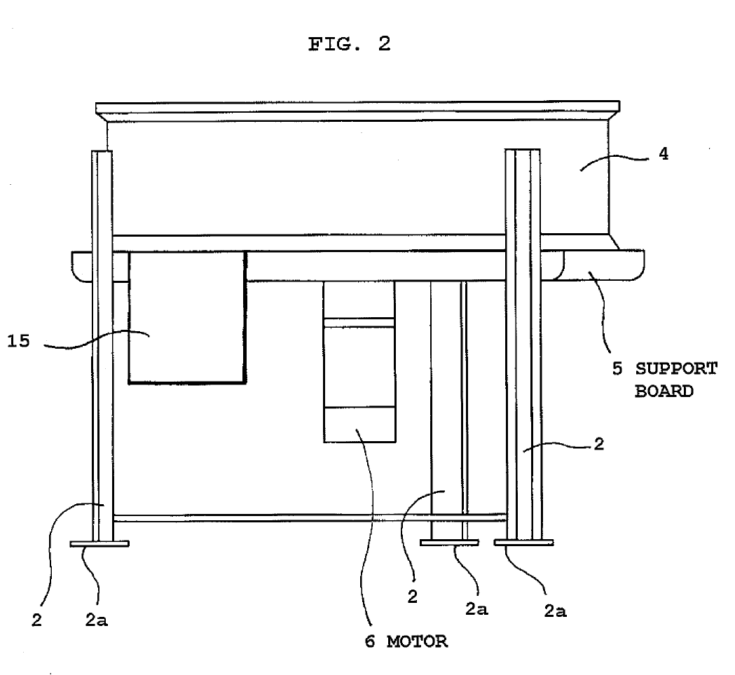

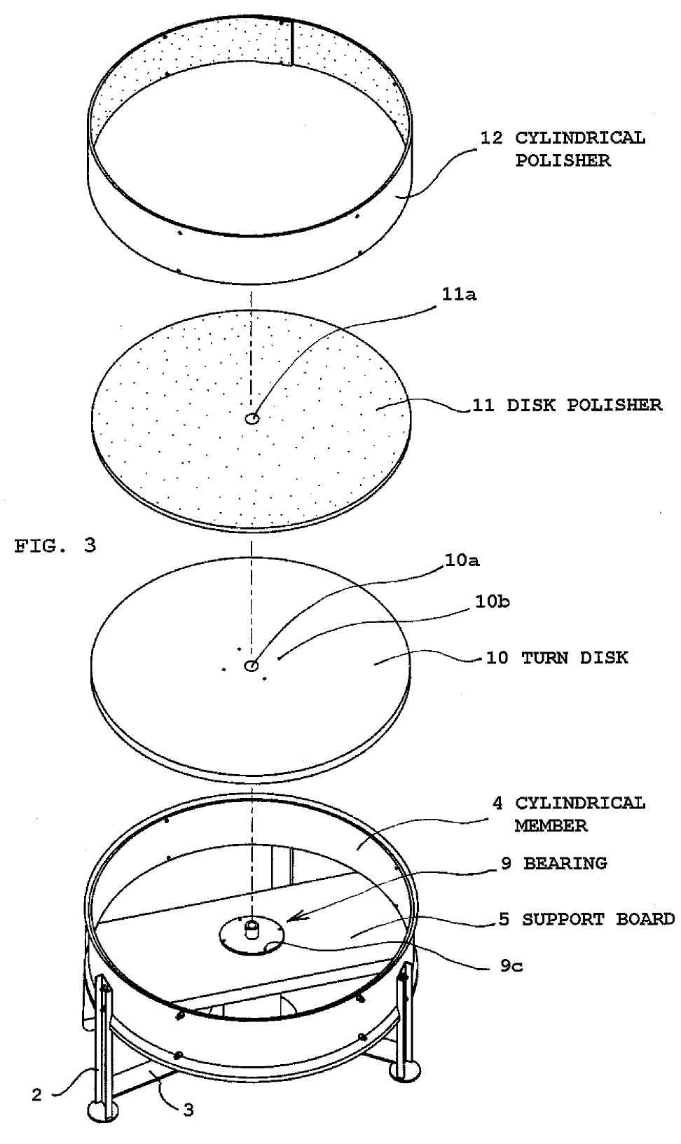

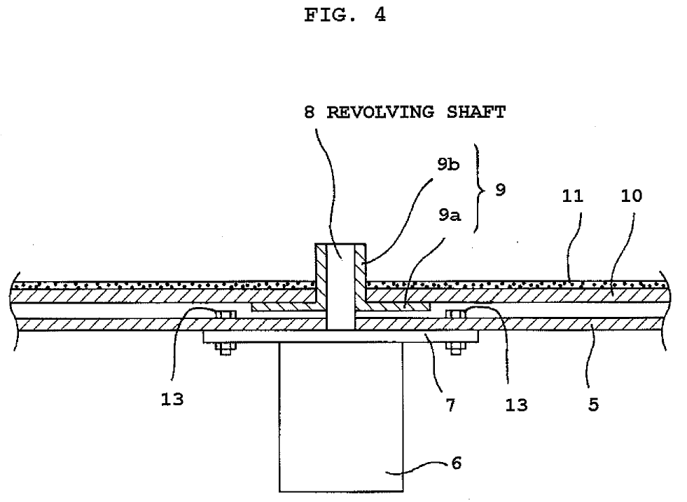

An embodiment of a citrus fruits polishing apparatus according to the invention will be described below with reference to the drawings. FIG. 1 is a perspective view of a citrus fruits polishing apparatus according to the invention, FIG. 2 is a side elevational view thereof, FIG. 3 is an exploded assembly drawing of the invention, and FIG. 4 is a fragmentary vertical sectional view of an essential part thereof along a centerline.

In the figures, 1 denotes a citrus fruits polishing apparatus according to the invention. 4 is a hollow cylindrical member having an upper portion and a bottom portion opened. The cylindrical member is supported at a predetermined height by legs 2 fixed to the external face thereof at predetermined intervals. In an example illustrated in the figures, three legs 2 are fixed to the external face of the cylindrical member 4. Each of the legs 2 is provided with a stabilizing pad 2a extending in a horizontal direction at the lower end portion of the leg. The legs 2 are connected to each other with lateral bars 3 at the lower face side of the cylindrical member 4. With this arrangement, the cylindrical member 4 is supported stably. The lateral bars 3 and the stabilizing pads 2a may be omitted.

The cylindrical member 4 is provided with a support board 5 having a predetermined width. The cylindrical member 4 extends through the center of the cylindrical member 4 and is fixed to the open bottom thereof. A motor 6 is disposed on the bottom face of the support board 5 in a central area of the cylindrical member 4. A revolving shaft 8 of the motor 6 protrudes upward from the support board 5. The motor 6 is fixed to the support board 5 by fixing a flange 7 of the motor 6 to the support board 5 with bolts 13. A bearing 9 is mounted over the revolving shaft 8 of the motor 6. The bearing 9 is composed of a horizontal plate 9a and a hollow vertical cylinder 9b vertically integrated therewith. The revolving shaft 8 is inserted through the vertical cylinder 9b in close contact with each other. The revolving shaft 8 and the vertical cylinder 9b are constantly connected with each other with a pin (not shown). With this arrangement, when the revolving shaft 8 is driven to rotate, the bearing 9 is also driven to rotate integrally therewith. The revolving shaft 8 can be driven to repeat rotation and stoppage intermittently at regular intervals, or to change the rotation direction regularly or at random.

10 denotes a turn disk. The bearing 9 is inserted through a hole 10a formed in the center of the turn disk 10, and the turn disk 10 is placed on the horizontal plate 9a. Bolts (not shown) are inserted into bolt holes 10b formed in the turn disk 10 and bolt holes 9c formed in the horizontal plate 9a, thus the turn disk 10 is integrally fixed to the bearing 9. Therefore, the turn disk 10 is disposed at the bottom of the cylindrical member 4 being slightly spaced from the inner periphery of the cylindrical member 4. Thus, the inner periphery of the cylindrical member 4 is vertically disposed around the turn disk 10. Therefore, when the bearing 9 rotates, the turn disk 10 is also integrally driven to rotate within the inner periphery of the cylindrical member 4.

11 denotes a disk polisher composed of an appropriate material having generally the same shape as that of the upper face of the turn disk 10. The bearing 9 is inserted through a hole 11a formed in the center of the disk polisher 11. The disk polisher 11 is placed on the turn disk 10 and fixed thereto with screws or the like (not shown). The inner periphery of the cylindrical member 4 is also provided with a cylindrical polisher 12 composed of an appropriate material. The cylindrical polisher 12 has generally the same shape as that of the inner periphery of the cylindrical member 4 and is fixed thereto with appropriate screws or the like (not shown). As for the disk polisher 11 and the cylindrical polisher 12, the material thereof is not particularly limited. If the material is capable of polishing citrus fruits, any type of material may be employed. For example, a material of natural fibers or chemical fibers having a predetermined thickness and hardness is preferred. A recycled material may be used for the polisher. In this embodiment, a piled rug is used being cut into the above-mentioned shapes and satisfactory results are obtained. When polishing citrus fruits utilizing the oil content contained within the peel of citrus fruits by extracting the oil content to the surface of the citrus fruits, a slightly hard material is suitable.

Referring to FIG. 2, 15 is a control panel fixed to a side face of the support board 5. The control panel 15 is provided with a timer (not shown) for setting ON/Off control, operation time and the like of the citrus fruits polishing apparatus 1. Using the timer, the citrus fruits polishing apparatus 1 is controlled so that the turn disk 10 is rotated for a period of time previously set according to the size and quantity of the citrus fruits to be polished; thereby the citrus fruits are polished for an appropriate period of time. Further, the control panel 15 is provided with a control device such as a rotation control unit or the like necessary for controlling the rotation mode of the turn disk 10. That is, the control unit controls the rotation direction, a regular rotation for a specific period of time, a rotation in which the rotation direction is reversed at random, and an intermittent rotation in which rotation and stoppage is repeated at a specified period of time.

The operation method of the citrus fruits polishing apparatus 1 having the above-described constitution is described below. If the visual quality is increased and the commercial value is enhanced by polishing before shipping, citrus fruits to be polished are not particularly limited. The citrus fruits polishing apparatus 1 is applicable to pomelos, tangerines such as mandarin oranges and Ponkan, oranges such as navel oranges and Valencia oranges, grapefruits, kumquats, tangors like Iyokan, aromatic citrus fruits such as Yuzu, Sudachi, lemons and limes, and other citrus fruits like Natsumikan and Hassaku.

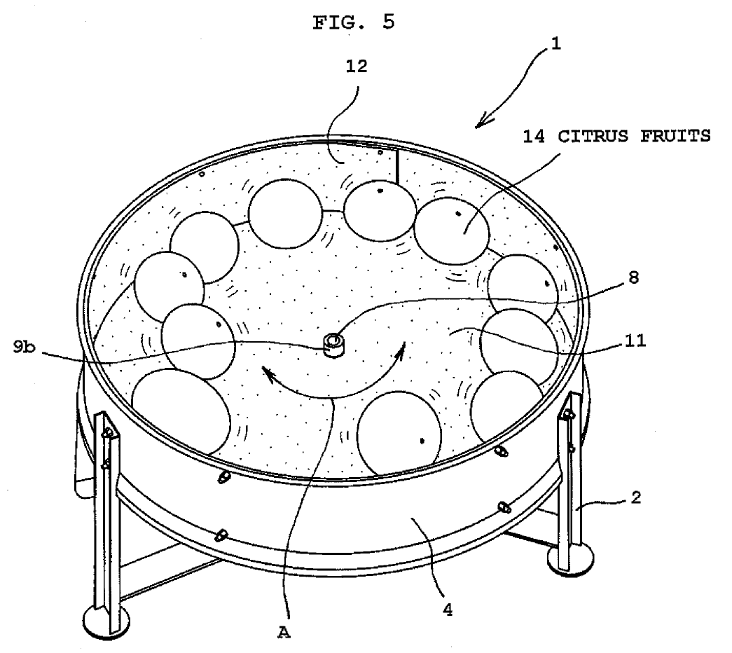

First of all, as illustrated in FIG. 5, after washing, a predetermined number of citrus fruits 14 to be polished are placed on the disk polisher 11. Then, a switch (not shown) is turned ON to activate the motor 6. When the motor 6 rotates, the bearing 9 is rotated via the revolving shaft 8, and the turn disk 10 fixed with the disk polisher 11 is rotated. With this rotation, the citrus fruits 14 placed on the disk polisher 11 are caused to roll, move and collide with each other thereon, and come into contact with the cylindrical polisher 12 and repeat the rolling while moving thereon. With this movement, the citrus fruits 14 come into contact with the disk polisher 11 and the cylindrical polisher 12, and thus the citrus fruits 14 are polished. As a result, the visual quality of the citrus fruits 14 is increased so that the citrus fruits 14 look attractive, enhancing the commercial value thereof.

At this time, the citrus fruits 14 come into contact with the disk polisher 11 and the cylindrical polisher 12, and further the citrus fruits 14 come into contact with each other. Thus, the oil content is extracted to the skin of the citrus fruits 14, and with this oil content, the citrus fruits 14 are polished more effectively. Further, the revolving shaft 8 is driven to change the rotation direction regularly or at random at every specific time as indicated with an arrow “A”, or to repeat rotation and stoppage at every regular time to perform an intermittent rotation; thereby the effectiveness of the polishing can be increased. Furthermore, the turn disk 10 is rotated for a previously set period of time in accordance with the size and/or quantity of the citrus fruits to be polished; thereby the polishing is carried out for an appropriate period of time.

As described above, according to the citrus fruits polishing apparatus of the invention, with the rotation of the turn disk, the citrus fruits are caused to roll on the disk polisher, and are repeatedly brought into contact with the disk polisher and the cylindrical polisher vertically disposed around the disk polisher. Thereby, the citrus fruits are polished to have a higher visual quality. When the citrus fruits are caused to roll and come into contact with the disk polisher and the cylindrical polisher, the oil content is extracted to the skin of the citrus fruits. Utilizing the oil content, the citrus fruits are further polished. Furthermore, since the citrus fruits are appropriately brought into contact with each other, the extraction of the oil content and the rolling of the citrus fruits are promoted. Therefore, the citrus fruits can be polished in a short period of time with a simple arrangement. As a result, the visual quality of the citrus fruits is increased, generating a higher commercial value.

Accordingly, the invention is capable of increasing the visual quality of citrus fruits such as pomelos, tangerines, oranges, grapefruits, kumquats, tangors, aromatic citrus fruits and other citrus fruits to enhance the commercial value of the citrus fruits before shipping.

1. A citrus fruits polishing apparatus, comprising:
a disk polisher fixed to a turn disk driven to rotate; and
a cylindrical polisher fixed to the inner periphery of a cylindrical member vertically disposed around the turn disk.

2. A citrus fruits polishing apparatus, comprising:
a support board fixed to an open bottom of a cylindrical member;
a motor fixed to the support board with a revolving shaft protruding upward;
a bearing mounted over the revolving shaft of the motor;
a turn disk rotatably fixed to the bearing;
a disk polisher fixed onto the turn disk; and
a cylindrical polisher fixed to the inner periphery of the cylindrical member.

3. The citrus fruits polishing apparatus according to claim 2, wherein a plurality of legs is fixed to the external face of the cylindrical member at predetermined intervals to thereby support the cylindrical member at a predetermined height.

4. The citrus fruits polishing apparatus according to claim 3, wherein the turn disk is driven to rotate intermittently.

5. The citrus fruits polishing apparatus according to claim 4, wherein the turn disk is driven to reverse the rotation direction thereof regularly or at random.

6. The citrus fruits polishing apparatus according to claim 5, wherein the turn disk is driven to rotate for a predetermined set period of time.

7. The citrus fruits polishing apparatus according to claim 6, wherein the turn disk is driven to rotate to cause citrus fruits placed on the disk polisher to roll to thereby bring the citrus fruits into contact with the disk polisher and the cylindrical polisher, whereby the citrus fruits are polished.

8. The citrus fruits polishing apparatus according to claim 6, wherein the turn disk is driven to rotate to cause citrus fruits placed on the disk polisher to roll to thereby bring the citrus fruits into contact with the disk polisher, the cylindrical polisher and with each other, whereby oil content is extracted to the skin of the citrus fruits and the citrus fruits are polished therewith.

9. The citrus fruits polishing apparatus according to claim 6, wherein the turn disk is driven to rotate to cause citrus fruits placed on the disk polisher to roll to thereby bring the citrus fruits into contact with the disk polisher, the cylindrical polisher and with each other, whereby oil content is extracted to the skin of the citrus fruits, and the skin of the citrus fruits is polished by the disk polisher and the cylindrical polisher to give luster to the skin thereof.

10. The citrus fruits polishing apparatus according to claim 1, wherein the turn disk is driven to rotate intermittently.

11. The citrus fruits polishing apparatus according to claim 1, wherein the turn disk is driven to reverse the rotation direction thereof regularly or at random.

12. The citrus fruits polishing apparatus according to claim 1, wherein the turn disk is driven to rotate for a predetermined set period of time.

13. The citrus fruits polishing apparatus according to claim 1, wherein the turn disk is driven to rotate to cause citrus fruits placed on the disk polisher to roll to thereby bring the citrus fruits into contact with the disk polisher and the cylindrical polisher, whereby the citrus fruits are polished.

14. The citrus fruits polishing apparatus according to claim 1, wherein the turn disk is driven to rotate to cause citrus fruits placed on the disk polisher to roll to thereby bring the citrus fruits into contact with the disk polisher, the cylindrical polisher and with each other, whereby oil content is extracted to the skin of the citrus fruits and the citrus fruits are polished therewith.

15. The citrus fruits polishing apparatus according to claim 1, wherein the turn disk is driven to rotate to cause citrus fruits placed on the disk polisher to roll to thereby bring the citrus fruits into contact with the disk polisher, the cylindrical polisher and with each other, whereby oil content is extracted to the skin of the citrus fruits, and the skin of the citrus fruits is polished by the disk polisher and the cylindrical polisher to give luster to the skin thereof.

16. The citrus fruits polishing apparatus according to claim 1, wherein a plurality of legs is fixed to the external face of the cylindrical member at predetermined intervals to thereby support the cylindrical member at a predetermined height.
